(19) United States
(12) Patent Application Publication
(10) Pub. No.: US 2026/0044155 A1
(43) Pub. Date: Feb. 12, 2026

(54) METHOD FOR INVERTING DRIVING INSTRUCTIONS FOR A WORKING MACHINE

(71) Applicant: ZF Friedrichshafen AG, Friedrichshafen (DE)

(72) Inventors: Dieter Balz, Wangen im Allgäu (DE); Udo Brehmer, Friedrichshafen (DE); Raphael Gonzalez, Leutkirch (DE); Stefan Traub, Friedrichshafen (DE)

(73) Assignee: ZF Friedrichshafen AG, Friedrichshafen (DE)

(21) Appl. No.: 19/100,241

(22) PCT Filed: Jul. 5, 2023
(86) PCT No.: PCT/EP2023/068515

§ 371 Date: Jan. 31, 2025

(30) Foreign Application Priority Data
Aug. 3, 2022 (DE) 10 2022 208 041.6

(51) Int. Cl. G05D 1/646; G05D 1/229; G05D 105/05

(52) U.S. Cl. CPC G05D 1/646; G05D 1/229; G05D 2105/05

(57) ABSTRACT

A method for inverting driving instructions of a working machine includes a first step of entering and initiating a driving instruction. In a second step, position data of the working machine are associated with the driving instruction. In a third step, a cancellation of the driving instruction is entered and the driving instruction is terminated. In a fourth step, position data of the working machine are associated with the cancellation of the driving instruction. With reference to the associated position data a corridor for the driving instruction is defined, and in a fifth step the driving instruction is inverted in such manner that the driving instruction is initiated and cancelled in the reverse sequence when the working machine travels along the corridor in the reverse direction.

### RELATED APPLICATIONS

This application claims the benefit under 35 U.S.C. § 371 as a U.S. National Phase Application of application no. PCT/EP2023/068515, filed on 5 Jul. 2023, which claims the benefit of German Patent Application no. 10 2022 208 041.6 filed on 3 Aug. 2022, the contents of which are hereby incorporated herein by reference in their entireties.

### FIELD OF THE DISCLOSURE

The present invention relates to a method for inverting and implementing driving instructions for a working machine, and to a device for data processing which is designed to carry out the method for inverting driving instructions. In addition, a computer program product and a working machine with a device according to the invention for data processing are included.

### BACKGROUND

From the prior art methods for carrying out repetitive handling instructions are known. In particular, EP 3 559 355 A1 discloses a method for operating at least one working machine, wherein at least one measurement device is operated for measuring a surface profile of the ground on a building site in order to generate actual surface profile data. Corresponding to a stored gradient, machine operating data which are assigned to gradients relating to the feature are called up from the databank and the working machine is operated on the basis of the machine operating data called up.

DE 10 2016 121 895 A1 describes a system for the automatic activation and deactivation of an all-wheel drive as a reaction to a vehicle-GPS-location. In this case, in particular information about a road type and weather conditions are taken into account.

DE 10 2009 045 511 A1 discloses a device and a method for learning a function of an operating assistance system in a motor vehicle, wherein a control instruction is associated with a location position and an operating assistance system is activated when the control instruction has already in the past been issued in a fixed number of cases. In a further development, the device should be capable of learning in such manner that routine tasks repeated as a function of location are automated.

### SUMMARY

The purpose of the present invention is to improve upon the known methods for operating a working machine. This objective is achieved by the method according to the invention. In this method, in a first step a driving instruction is entered and then initiated. This means that an operator enters an instruction different from the driving instruction currently in force. This can be done either on the spot in a cabin of the working machine, or remotely or with reference to commands stored in a storage element. Correspondingly, a man-machine interface is provided in the cabin, or a data interface for a remote-control system is provided. In this context, a driving instruction is understood to mean a specification of drive-dynamical parameters. These include for example a power and/or torque-rotation speed adaptation, a change of gear ratio, switching an all-wheel drive system on or off, activation or deactivation of a differential lock of an axle, deactivation or activation of a power take-off, deactivation or activation of a wear-free hydrodynamic or electrodynamic permanent brake, deactivation or activation of a driving mode (Eco, Power, Recuperation), or the like.

The working machine is typically a building machine, an agricultural machine, and/or a forestry machine. Similarly, however, it can also be a utility vehicle or an industrial transporter. Besides conventionally controlled working machines (ones controlled by an operator in a cabin), the entering of a driving instruction can take place in partially automated or automated working machines.

In a second step of the method according to the invention, position data of the working machine are associated with the driving instruction entered. This means that the by virtue of position determination means, a position of the working machine at the moment when the driving instruction is entered is determined, which is linked to or associated with the driving instruction and stored in the storage element. Besides the absolute position data, a previously stored trajectory or a driving direction can also be taken into account and stored. The position determination can for example take place in an absolute co-ordinate system or in a relative co-ordinate system. Suitable means for position determination in an absolute co-ordinate system are, for example, GPS sensors or the like. However, other systems too can be used for position determination or location.

Thereafter, in a third step, a cancellation of the driving instruction is entered. This input too takes place either by an operator or remotely in the manner described earlier. The result of the cancellation is that the driving instruction is terminated. In other words, a drive-dynamical parameter activated in the first step is deactivated, or conversely, a drive-dynamical parameter deactivated is reactivated. In a fourth step position data of the working machine are associated with the cancellation of the driving instruction and stored in the storage element together with the cancellation of the driving instruction.

With reference to the position data associated with the driving instructions, or with the cancellation of the driving instruction, a corridor for the driving instruction is defined, such that in a fifth step the driving instruction is inverted with the result that the driving instruction is initiated and cancelled in the reverse sequence when the working machine travels along the corridor in the reverse direction. In particular the corridor constitutes a path which is defined by the position data when the driving instruction was entered and when the cancellation of the driving instruction was entered. To express it differently, the corridor describes a vector with an explicit start and end point and a defined direction. In various embodiments various corridors can be formed, and various driving instructions stored in the storage element can be carried out in combination with one another or individually in their own right.

In a further development of the invention, if the working machine travels along the corridor again, then depending on the direction in which that takes place the driving instruction is carried out in the original sequence or in the reverse sequence. This means that if the path is travelled in the direction first used (steps 1 to 4) the steps are repeated automatically in that same sequence. Consequently, by inverting the steps, the steps 1 to 4 are carried out or repeated in the reverse sequence when the working machine travels along the corridor in the reverse direction, i.e. opposite to the original direction.

Alternatively, or in addition, the corridor of the driving instruction has a tolerance range such that the tolerance range, besides allowing for a different approach angle of the working machine relative to the corridor, also takes into account a partial deviation and/or a complete deviation of a trajectory. This is understood to mean that on the one hand the trajectory is taken into account as the corridor is approached, and on the other hand an inexact overlap with the vector or the corridor is also allowed for. Here, a partial deviation means that in some parts there is a deviation from the current trajectory to the corridor. In one design, the current trajectory may coincide with the corridor only at a single point or, however, only deviate from it in at least one point. A complete deviation means, for example, that the actual trajectory or travel path of the working machine deviates wholly from the corridor or vector, but bs a (permissible) amount.

In a further-developed embodiment, a current and/or planned trajectory is checked in relation to the travel along the corridor and the driving instruction is initiated predictively. This means that it is determined whether with the current or planned trajectory it is assumed that the corridor will be covered in the original, or in the reverse direction, so that already in advance preparations can be made for the adaptation of the drive-dynamical parameter. For example, an operating mode of the working machine can already be adapted in advance. A planned trajectory emerges, for example, from a route guidance system of the working machine with reference to a navigation system. Consequently, a check is carried out to see whether a planned route or trajectory passes through the corridor. The drive-dynamical parameter can then also be adapted in a predictive or forward-looking manner.

In one design version, the driving instruction is inerted by an operator's input. For that purpose, it can be provided that after the cancellation of the driving instruction has been entered by means of the man-machine interface, a query follows to see whether an inversion of the driving instruction should be carried out and stored in the storage element. Accordingly, this must be followed by an entry to confirm or reject. It is also possible to select a mode already in advance, following which a repetition (playback function) can be selected or deactivated. This has the result that carrying out the driving instruction takes place automatically. Sometimes, by way of the man-machine interface an indication can be emitted the driving instruction will be carried out automatically when the corridor is travelled on. This can relate to a single driving instruction or in general to all the driving instructions. The query about inverting can also be made already at the time when the driving instruction is entered. That also applies to a query whether when the corridor is travelled on again, a repetition of the driving instruction in the original direction or the reverse direction should take place.

In the above-described design version, the entry of the driving instruction brings about an adaptation of drive-dynamical parameters of the working machine. In particular, in this way a drive-dynamical parameter can be adapted on account of a topographical change of the route (uphill or downhill gradient, etc.), a condition of the roadway (dry, moist, wet, icy, gravel, shingle, sand, etc.), or on account of obstacles that can be driven over or through (stream, sinkhole, earth pile, rubble, etc.). This results in more efficient operation of the working machine, since on the one hand a drivetrain can be operated in an optimal operating range and on the other hand the work outcome is improved because a better working performance of the working machine can be achieved.

According to a further aspect, the present invention relates to a computer program product. This contains commands which, when the program is run on a computer, enable it to carry out the method according to the invention. The computer can typically be a control unit of the working machine. As examples but not exclusively, a transmission control unit, a motor control unit or a higher-level vehicle control computer can be mentioned. A separate control unit can also be provided, which is designed exclusively for the method according to the invention or which, besides the method according to the invention, can also implement other functions. The storage element can be integrated in the aforesaid control unit, or it can be provided separately.

Furthermore, the invention relates to a device for data processing. This contains means for carrying out the method according to the invention. In particular, the device can be the aforesaid computer or the control unit concerned.

In addition, the invention also relates to a working machine with a drivetrain and means for adapting drive-dynamical parameters and the device according to the invention. The drivetrain includes, for example, a drive element, a transmission, axles, and brakes by means of which a drive power of the drive element is transmitted to wheels or a chain drive of the working machine. The drive element can be in the form of an internal combustion engine and/or an electric machine. Moreover, the drivetrain can comprise differential locks which either lock or release a differential gear system of an axle or between two axles. The means for adapting drive-dynamical parameters are in particular actors which change a status of the above-mentioned elements of the drivetrain. In a possible design version, the means also include for example a motor control unit by which the operating status of the drive element is adapted (for example, adaptation of the rotation speed, the torque, or the power).

### BRIEF DESCRIPTION OF THE DRAWINGS

The invention will be explained in greater detail with reference to the attached figures, which show:

FIG. 1: A first example application of the method according to the invention in a working machine;

FIG. 2: The carrying out of the process steps of the first example application, but in reverse;

FIG. 3: An alternative way of carrying out an example application of the method according to the invention in a working machine.

### DETAILED DESCRIPTION

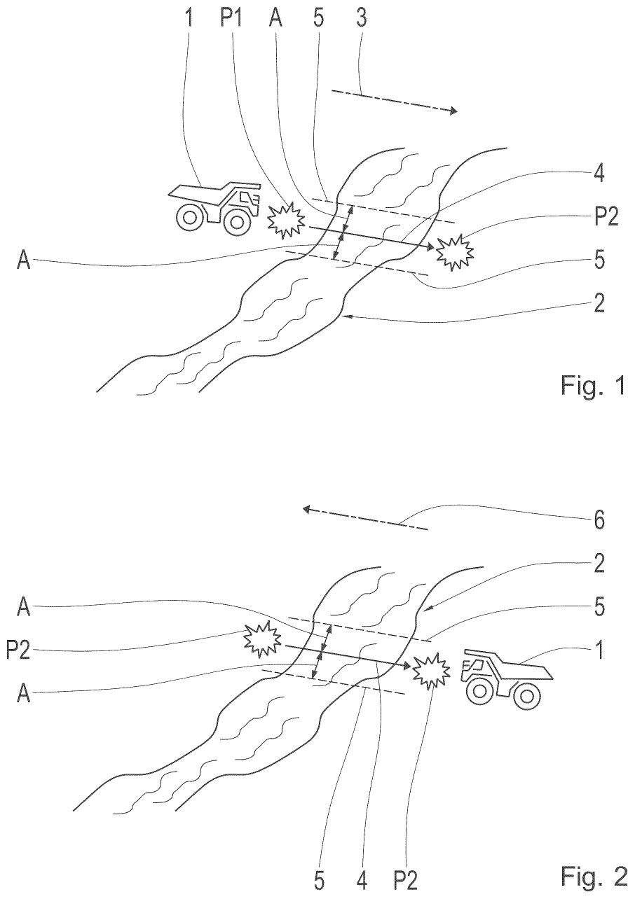

FIG. 1 shows a first example application of the method according to the invention. In this case the working machine 1 is in the form of a dumper truck, i.e., a so-termed dumper. The figures also show an obstacle 2 in the form of a stream, which must be crossed in a first travel direction 3. In a first position P1 a driving instruction is entered, wherein relative to the first travel direction 3 the first position P1 is ahead of the obstacle 2. For example, by virtue of the driving instruction one or more differential locks can be activated since to cross the stream optimum traction is required and getting stuck must be unconditionally avoided. Once the obstacle 2 has been overcome, at a second position P2 the cancellation of the driving instruction is entered. In the example as described, this results in deactivation of the differential locks. In a similar manner the driving requirements mentioned earlier can be transposed or applied to the example application described in this case.

The path between the first position P1 and the second position P2 defines a corridor 4 for the activation of the driving instruction. In FIG. 1 a tolerance range 5 is indicated by broken lines. In this example, an upper and a lower limit of the tolerance range are an identical distance A away from the corridor 4. In principle, however, the distance A between the upper limit and the corridor 4 and the lower limit and the corridor 4 can be different from one another. Accordingly, when it next travels the working machine may not follow the corridor 4 exactly, but it will be within the tolerance range 5 so that an automatic repetition of the driving instruction takes place.

FIG. 2 shows schematically the initiation of the inverted driving requirement from FIG. 1. In this case the working machine 1 moves in a second travel direction 6, this second travel direction 6 being opposite to the first travel direction 3. In other words, the working machine 1 moves along the corridor 4 in the reverse direction compared with that shown in FIG. 1. Consequently, the steps of the method are reversed. This means that now, at the second position P2, instead of deactivating the differential lock it is activated, and at the first position P1 instead of activating the differential lock it is deactivated. The driving requirement and the cancellation of the driving requirement as when moving in the first direction 3 are accordingly mirror-image reversed. As a result, the operator does not need to enter anything manually in order to bring about the desired adaptation of the drive-dynamical parameter, even though the working machine 1 will occasionally be travelling along the corridor 4 in the second direction 6 for the first time.

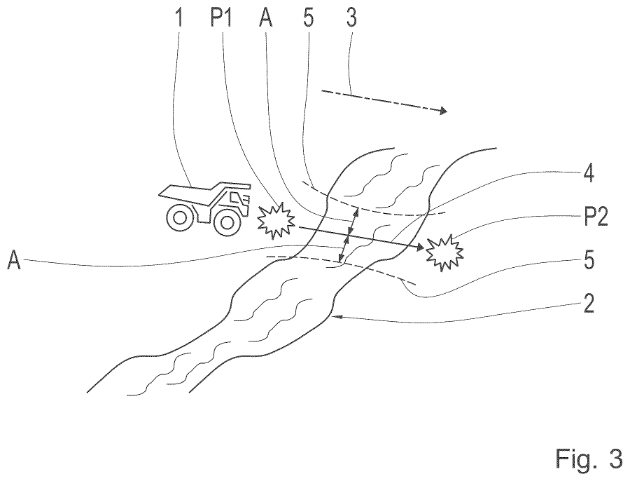

FIG. 3 shows essentially the same features as FIG. 1. The difference consists in the different shape of the tolerance range 5. In this case the upper and lower limits are demarcated not by straight lines but by curved lines. Thus, the tolerance range 5 is narrower in the middle, whereas in the direction of the first and second positions P1 and P2 it widens out in a funnel shape. Sometimes, as regards the tolerance range 5 the operator can enter a preference specifying the shape of the tolerance range 5 that he wants. The shape shown in FIG. 3 is particularly suitable when a deviating starting angle of the working machine 1 is to be expected more often at the first and/or the second position P1, P2.

### INDEXES

1 Working machine
2 Obstacle
3 First travel direction
4 Corridor
5 Tolerance range
6 Second travel direction
A Distance
P1 First position
P2 Second position

1-10. (canceled)

11. A method for inverting driving instructions of a working machine (1), comprising:
entering and initiating a driving instruction;
associating position data of the working machine (1) with the driving instruction,
cancelling the entered driving instruction is entered and terminating the driving instruction; and
associating position data of the working machine (1) with the cancellation of the driving;
defining a corridor based on the position data of the working machine associated with the driving instruction; and
inverting the driving instruction in such manner that the driving instruction is initiated and cancelled in the reverse sequence when the working machine (1) travels along the corridor (4) in the reverse direction.

12. The method according to claim 11, comprising:
the working machine again traveling along the corridor (4); and
carrying out the driving instruction in the original sequence or in the reverse sequence depending on the direction of the working machine again travels in the corridor.

13. The method according to claim 11, comprising:
defining a tolerance range for the corridor (4) associated with the driving instruction, wherein the tolerance range (5), besides a deviation of the starting angle of the working machine (1), allows for a partial and/or complete deviation of a trajectory in relation to the corridor (4).

14. The method according to claim 11, comprising:
checking a current and/or planned trajectory in relation to the travel along the corridor (4); and
predictively initiating the driving instruction.

15. The method according to claim 11, comprising inverting the driving instruction in response to an entry by an operator.

16. The method according to claim 11, comprising:
receiving an entered driving instruction; and
querying the user as to whether the driving instruction should be inverted.

17. The method according to claim 11, comprising:
cancelling an entered driving instruction; and
querying the user as to whether the driving instruction should be inverted.

18. The method according to claim 11, comprising adapting drive-dynamical parameters of the working machine (1) based on the driving instruction.

19. A computer program product containing commands which, when the program is run on a computer, enable it to carry out the method according to claim 11

20. A device for data processing, comprising means for carrying out the method according to claim 11.

21. A working machine (1) comprising:
a drivetrain;
means for adapting drive-dynamical parameters; and
a device comprising means for carrying out the method according to claim 11.
